(19) United States
(12) Patent Application Publication
(10) Pub. No.: US 2018/0177322 A1
(43) Pub. Date: Jun. 28, 2018

(54) LOW VACUUM AND VACUUM RELEASE DEVICE FOR ELECTRIC RICE COOKER

(71) Applicant: SAMMI INDUSTRIAL CO., Seoul (KR)

(72) Inventor: Cha Sik KIM, Seoul (KR)

(21) Appl. No.: 15/739,922

(22) PCT Filed: Mar. 16, 2016
(86) PCT No.: PCT/KR2016/002610

§ 371 Date: Mar. 19, 2018

(30) Foreign Application Priority Data
Mar. 17, 2015 (KR) 10-2015-0036966

(51) Int. Cl. A47J 27/08; A47J 27/62; A47J 27/092

(52) U.S. Cl. CPC A47J 27/0802; A47J 27/62; F16K 17/06; A47J 27/0815; A47J 27/092

(57) ABSTRACT

The present invention relates to a low vacuum and vacuum release device for an electric rice cooker, the device being capable of releasing a vacuum and maintaining a vacuum state by the rotation of an operation lever. The electric rice cooker has: the operation lever provided at the upper part of a lid; and the low vacuum and vacuum release device provided inside the lid, elastically connected to the operation lever such that when the operation lever is rotated, the device rises so as to open an air inlet, thereby releasing the vacuum while external air flows therein, and when the operation lever is released, the device lowers by the elastic force of a spring so as to maintain the vacuum state by blocking the air inlet, wherein the low vacuum and vacuum release device comprises: a housing provided in the inside of the lid; a first pressure opening/closing operation part provided inside the housing and rising or lowering according to the vapor pressure during cooking, thereby opening or closing the first vapor outlet of a first lower sealing member; a second vacuum release operation part provided inside the housing and rising or lowering according to the rotation of the operation lever, thereby opening or closing the air inlet of a second lower sealing member; and a raising/lowering operation connection part provided at the upper part of the housing and raising or lowering the second vacuum release operation part while being mounted with the operation lever.

### TECHNICAL FIELD

The present invention relates to a low vacuum and vacuum release device for an electric rice cooker, and more particularly, to a low vacuum and vacuum release device for an electric rice cooker, which is capable of releasing and maintaining a vacuum state according to a rotation of an operation lever.

### BACKGROUND ART

Generally, a pressure cooker has an advantage in that a boiling point becomes much higher than that of an atmospheric pressure state since a pressure inside a cooker is increased by heating in a sealed state, so that foods are sufficiently cooked. Pressure cookers may be divided into direct heating type pressure cookers and electric heating type pressure cookers depending on the heating source.

Looking at a schematic structure of an electric pressure cooker with reference to FIG. 1, an electric pressure cooker 170 is configured to include a main body 172, a cover 171, an oven 177 accommodated in the main body 172, a working coil 179a configured to heat the oven 177, a heater 179b configured to keep warmth, and a vapor discharge part configured to adjust a pressure inside the oven 177 during cooking.

According to a function, the vapor discharge part is configured with a poise valve 173 configured to be opened when a pressure inside the oven 177 exceeds a predetermined value during cooking, thereby preventing the pressure inside the oven 177 from rising excessively and simultaneously allowing the pressure to be kept constant; and a solenoid valve 175 configured to lower the pressure inside the oven 177 by being opened under the control of a control unit after cooking starts and a predetermined amount of time passes.

The poise valve 173 is configured with a vapor outlet pipe 173a installed to pass through the cover 171 and with a pressure weight 173b disposed at an upper portion of the vapor outlet pipe 173a outside the cover 171, and a valve pin 173c is formed inside the pressure weight 173b to open and close the vapor outlet pipe 173a.

Unlike the electric pressure cooker shown in FIG. 1, a direct heating type pressure cooker does not require the working coils 179a and heater 179b, and in terms of the vapor discharge part, the poise valve 173 is present like in the electric pressure cooker, but an auxiliary safety valve is provided instead of the solenoid valve 175.

In using such a conventional pressure cooker, it is possible to carry out a process of macerating grain such as rice or soybeans before cooking, and cooked food is frequently stored in the pressure cooker for a certain amount of time after cooking.

Even when the pressure cooker is left in a closed state by closing the cover before or after cooking, the cooked food may be spoiled by various microorganisms such as bacteria, fungi, and yeast present in the air of the pressure cooker, various aerobic microorganisms and facultative microorganisms may be propagated, and various chemical reactions including oxidation reactions between gas molecules in the air and the cooked food may occur such that the cooked food may discolor.

Such problems may be prevented by vacuuming the pressure cooker.

As prior art related to the vacuuming of a rice cooker, there is Korean Registered Patent No. 0109950 (Dec. 30, 1996) entitled “Vacuum Warming Device for Electric Rice Cooker,” in which an outlet capable of forcibly discharging air inside the rice cooker is separately provided from a vapor outlet of a cover so that the air inside the electric rice cooker is totally discharged using a pump or push cap integrally attached to the electric rice cooker, thereby realizing vacuuming.

However, the above-mentioned Korean Registered Patent considers only keeping rice warm after the rice is cooked, and thus it is a technique for preventing the rice's taste from being changed and the rice from discoloring during warming.

Further, the above-mentioned Korean Registered Patent considers only a vacuum device which is integrally installed in the electric rice cooker such that a new mold design and a change in an existing production line increase the production cost, thereby lowering the price competitiveness, and since a structure of the electric rice cooker to which the lid is fixed is complicated, there are problems in that it is difficult for consumers to buy the electric rice cooker due to unfamiliarity with the function and appearance thereof, and also it is difficult to expect mass sales since the electric rice cookers are already provided in each household.

Furthermore, air is required to flow inside the electric rice cooker when the cover of the electric rice cooker is opened, but the above-mentioned Korean Registered Patent does not indicate a specific solution for the problem of how to open the cover.

As another conventional technique, there is Korean Patent Application Publication No. 2000-0008520 (Feb. 7, 2000) entitled “Vacuum Warming Method for Electric Rice Cooker,” which includes selecting a vacuum warming mode and recognizing the selected vacuum warming mode; a solenoid opening a pipe path for a solenoid valve while an oven is simultaneously heated; sensing a first temperature value of a lower portion of the oven and comparing the first sensed temperature value with a preset temperature value; stopping heating of the oven when the primarily sensed temperature value is equal to or higher than the preset temperature value; sensing a second temperature value of the lower portion of the oven and comparing the second sensed temperature value with the preset temperature value; and the solenoid blocking the pipe path for the solenoid valve when the secondarily sensed temperature value is lower than or equal to the preset temperature value.

The above-mentioned Korean Patent Application Publication also considers only preventing the rice's taste from being changed and the rice from discoloring during warming.

Further, the above-mentioned Korean Patent Application Publication employs a method of raising a pressure inside of the oven to be higher than atmospheric pressure and immediately reducing the pressure to below the atmospheric pressure to form a vacuum state, and thus heating and vacuuming are continuously repeated and the number of repetitions of the heating and the vacuuming is inevitably increased when the cover of the electric rice cooker is frequently opened and closed to take contents out of the electric rice cooker such that there is a problem in that the rice's taste is deteriorated due to the repetitive heating and the moisture content of the rice is lowered as well, causing dryness of the rice due to a repetitive air discharge.

### Disclosure

### Technical Problem

The present invention has been made in order to resolve the above problems, and it is an objective of the present invention to provide a low vacuum and vacuum release device for an electric rice cooker, which is installed at an operation lever configured to open and close a lid, thereby being capable of releasing a vacuum state inside the electric rice cooker or automatically maintaining the vacuum state therein with a rotation of the operation lever.

### Technical Solution

To attain the objective, according to one aspect of the present invention, there is provided a low vacuum and vacuum release device for an electric rice cooker, which includes an operation lever installed at an upper portion of a lid, wherein the low vacuum and vacuum release device may be installed inside the lid and may be elastically connected to the operation lever, and when the operation lever is rotated, the low vacuum and vacuum release device may be raised to open an air inlet such that outside air may flow in to release a vacuum state, and when the operation lever is released, the low vacuum and vacuum release device may be lowered by an elastic force of a spring to block the air inlet such that the vacuum state may be maintained.

The low vacuum and vacuum release device according to the present invention may include a housing installed inside the lid; a first pressure opening/closing operation part installed inside the housing and configured to open and close a first vapor outlet of a first lower sealing member by being raised and lowered according to a vapor pressure during cooking; a second vacuum release operation part installed inside the housing and configured to open and close an air inlet of a second lower sealing member by being raised and lowered according to a rotation of the operation lever; and a raising/lowering operation connection part installed at an upper portion of the housing and configured to raise and lower the second vacuum release operation part by being installed together with the operation lever.

The housing according to the present embodiment may include a second shaft guide movement space formed to vertically pass through the housing to allow the second vacuum release operation part to be inserted; a first shaft guide movement space into which the first pressure opening/closing operation part is inserted; and a second vapor outlet configured to communicate with the first shaft guide movement space and the first vapor outlet and allow vapor to be discharged according to raising and lowering of the first pressure opening/closing operation part.

Also, a guide protrusion may be provided at both sides of an inner wall surface of the second shaft guide movement space to allow the second vacuum release operation part to be vertically smoothly guided.

The first pressure opening/closing operation part according to the present embodiment may include a first upper sealing member guide inserted into the first shaft guide movement space of the housing; and a first upper sealing member installed below the first upper sealing member guide and configured to, by being raised and lowered by heating during cooking and according to the vapor pressure, open and close a second vapor outlet to open and close the first vapor outlet of the first lower sealing member to adjust discharge of a pressure.

A guide part may be installed at an outer circumference of the first upper sealing member guide to allow the first upper sealing member guide to be guided without being pulled out from the first shaft guide movement space.

Also, a spring may be installed outside the first upper sealing member guide to elastically support the first upper sealing member guide inside a first shaft guide movement space.

The second vacuum release operation part according to the present embodiment may include a vacuum release opening/closing operation shaft installed inside a second shaft guide movement space of the housing and configured to be raised and lowered according to the rotation of the operation lever; and a second upper sealing member installed at a lower portion of the vacuum release opening/closing operation shaft and configured to open and close the air inlet of the second lower sealing member.

The vacuum release opening/closing operation shaft may be inserted into the second shaft guide movement space of the housing, and an upper portion of the vacuum release opening/closing operation shaft may be fitted to the raising/lowering operation connection part and may be raised and lowered to open and close the air inlet of the second lower sealing member via the second upper sealing member such that outside air may flow in and be blocked to release and maintain the vacuum state inside a main body.

Also, a hook bump may be formed at an upper outer side of the vacuum release opening/closing operation shaft such that the vacuum release opening/closing operation shaft can be raised according to the rotation of the operation lever while being hooked inside the raising/lowering operation connection part.

At this point, the hook bump may be formed at both left and right sides of the raising/lowering operation connection part to allow the vacuum release opening/closing operation shaft to be smoothly raised and lowered without being inclined to one side.

Also, a guide recess may be formed outside the vacuum release opening/closing operation shaft, and a guide protrusion provided in the second shaft guide movement space may be inserted into the guide recess to allow the vacuum release opening/closing operation shaft to be vertically guided.

At this point, a plurality of guide recesses may be formed at both left and right sides of the vacuum release opening/closing operation shaft, and guide protrusions provided in the second shaft guide movement space may be inserted into the plurality of guide recesses to allow the vacuum release opening/closing operation shaft to be smoothly guided without being inclined.

A spring may be installed outside the vacuum release opening/closing operation shaft to elastically support the vacuum release opening/closing operation shaft inserted into the second shaft guide movement space of the housing.

The second upper sealing member of the present embodiment may be installed at a lower portion of the vacuum release opening/closing operation shaft by fitting, and a lower portion of the second upper sealing member may open and close the air inlet of the second lower sealing member according to raising and lowering of the vacuum release opening/closing operation shaft to maintain or release a vacuum state inside the main body.

Also, a guide plate may be installed at an outer circumference of the second upper sealing member to support the spring and guide the second upper sealing member.

The raising/lowering operation connection part according to the present embodiment may be installed above the second shaft guide movement space of the housing together with the operation lever, and the upper portion of the vacuum release opening/closing operation shaft may be inserted inside the raising/lowering operation connection part.

Also, a raising/lowering inclination guide part may be installed at an inner wall surface of the raising/lowering operation connection part, and when the vacuum release opening/closing operation shaft is inserted, a hook bump may be hooked to the raising/lowering inclination guide part, thereby raising and lowering the vacuum release opening/closing operation shaft according to the rotation of the operation lever.

Alternatively, raising/lowering inclination guide parts may be installed to cross each other and be inclined at both sides of the inner wall surface of the raising/lowering operation connection part.

Also, a bolt hole may be formed at an upper portion of the raising/lowering operation connection part to allow the raising/lowering operation connection part to be fixed to the operation lever by a bolt.

The operation lever may include a lower plate fixed to the raising/lowering operation connection part by a bolt and includes an upper plate installed at an upper portion of the lower plate by fitting.

### Advantageous Effects

As described above, in accordance with the low vacuum and vacuum release device of the electric rice cooker of the present invention, the low vacuum and vacuum release device connected to the operation lever and being capable of discharging vapor generated by heating during cooking and automatically adjusting a vacuum state inside the electric rice cooker by a rotation of the operation lever is installed inside the lid, so that, when the operation lever is rotated, the vacuum release opening/closing operation shaft is raised, the second upper sealing member opens the air inlet of the second lower sealing member, and the outside air flows in to release the vacuum state such that the lid can be opened, and when the operation lever is released, the vacuum release opening/closing operation shaft is lowered by the elastic force of the spring and the second upper sealing member blocks automatically the air inlet to maintain the vacuum state such that there is an effect in which convenience of the user can be enhanced and heat insulating efficiency can be maximized.

### DESCRIPTION OF DRAWINGS

FIG. 1 is a cross-sectional view of a structure of a conventional electric pressure cooker.

FIG. 2 is a perspective view of an electric rice cooker according to the present invention.

FIG. 3 is a perspective view of a lid of the electric rice cooker according to the present invention.

FIG. 4 is an exploded perspective view of a low vacuum and vacuum release device of the electric rice cooker according to the present invention.

FIG. 5 is a coupled perspective view of the low vacuum and vacuum release device of the electric rice cooker according to the present invention.

FIG. 6 is a cross-sectional view taken along a line A-A in FIG. 5.

FIG. 7 is a cross-sectional view taken along a line B-B in FIG. 5.

FIG. 8 is an exploded perspective view illustrating inner configurations of a vacuum release opening/closing operation shaft and a raising/lowering operation connection part of the low vacuum and vacuum release device according to the present invention.

FIG. 9 is an exploded perspective view illustrating the vacuum release opening/closing operation shaft and the raising/lowering operation connection part of the low vacuum and vacuum release device according to the present invention.

FIG. 10 is a coupled perspective view illustrating the vacuum release opening/closing operation shaft and the raising/lowering operation connection part of the low vacuum and vacuum release device according to the present invention.

FIG. 11 is a transverse sectional view of a lid provided with the low vacuum and vacuum release device of the electric rice cooker according to the present invention.

FIG. 12 is a longitudinal sectional view of the lid provided with the low vacuum and vacuum release device of the electric rice cooker according to the present invention.

FIG. 13 is an enlarged cross-sectional view of the lid in a state in which vapor of the electric rice cooker according to the present invention is discharged.

FIG. 14 is an enlarged cross-sectional view of the lid in a state in which a vacuum state of the electric rice cooker according to the present invention is released.

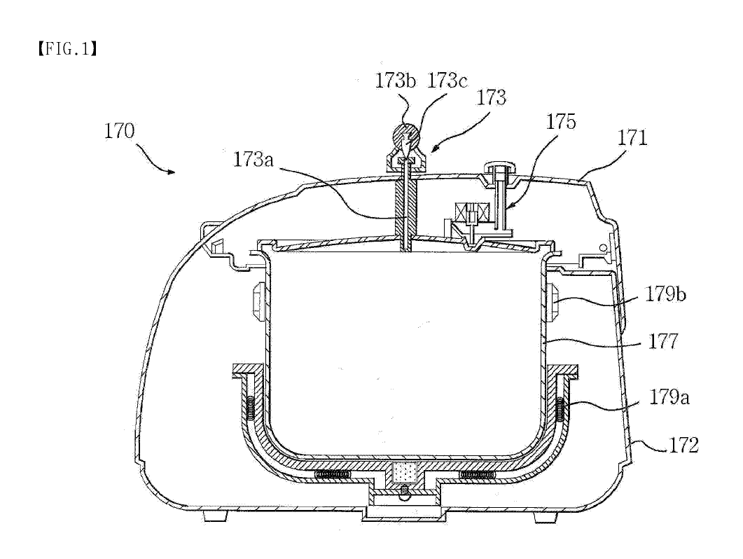

### MODES OF THE INVENTION

Hereinafter, one embodiment of the present invention will be described in detail with reference to the accompanying drawings.

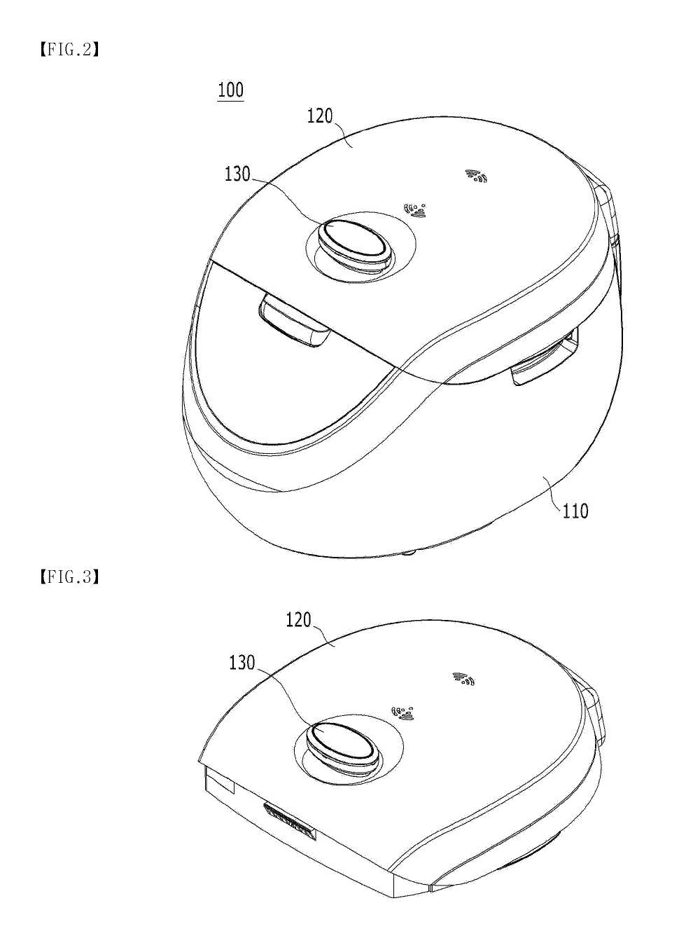

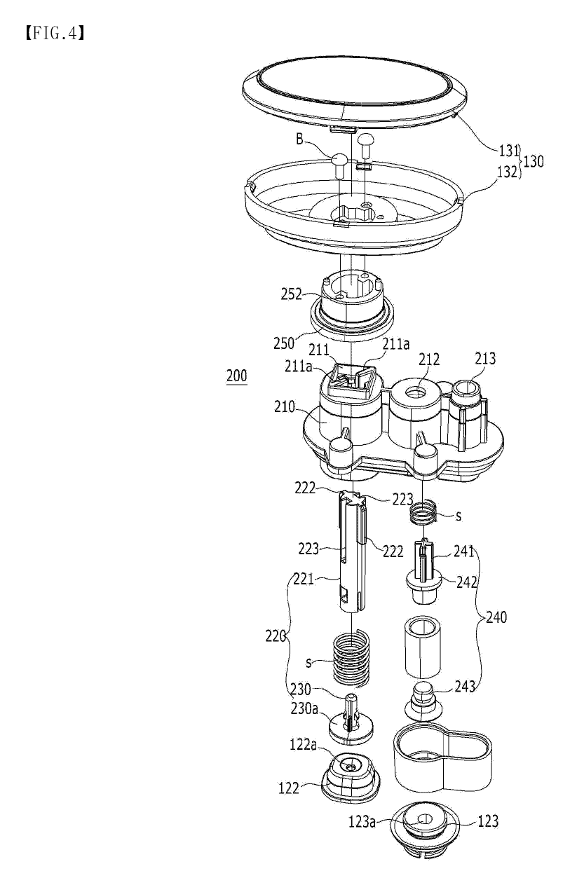

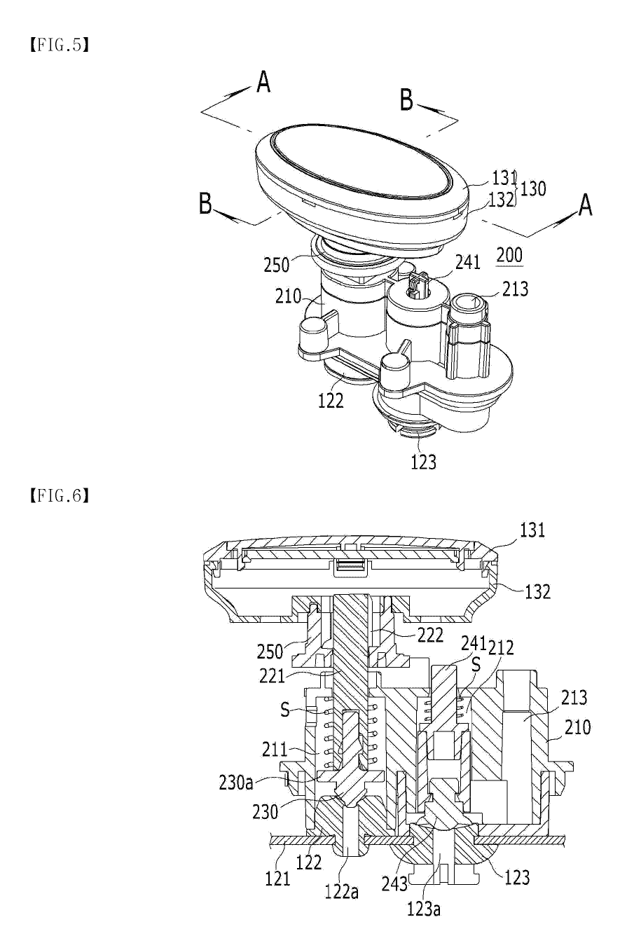

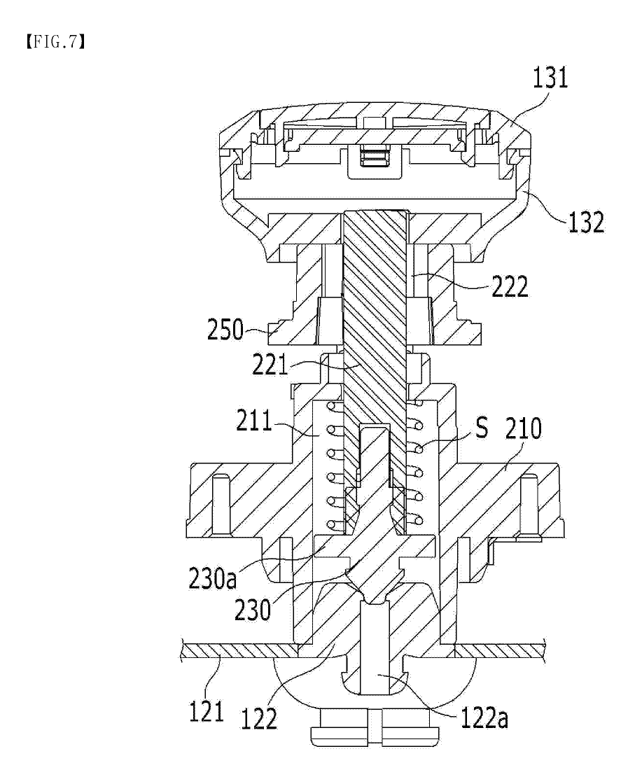

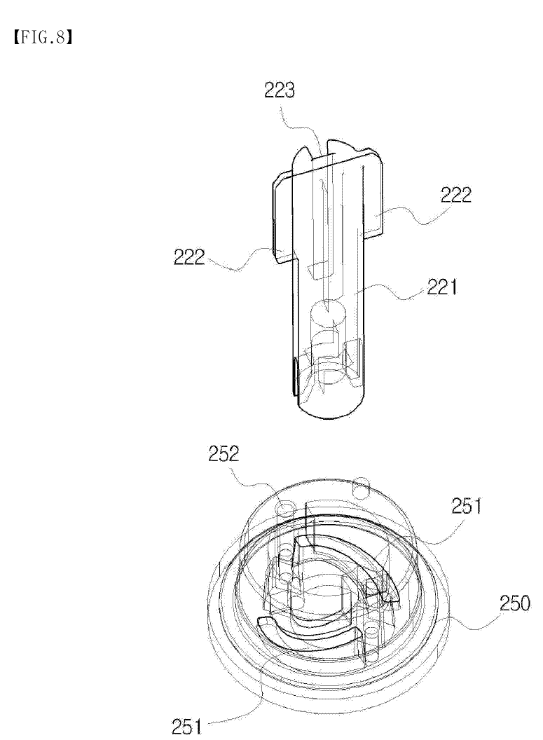

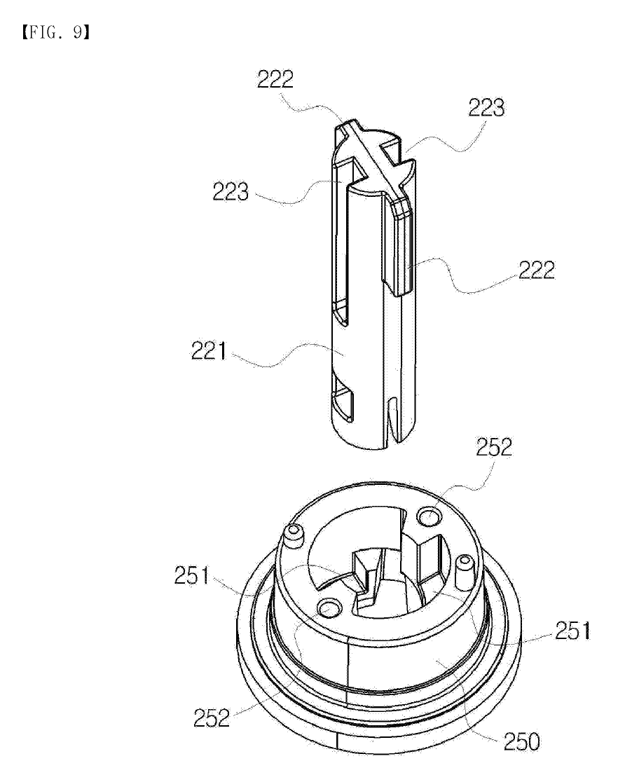

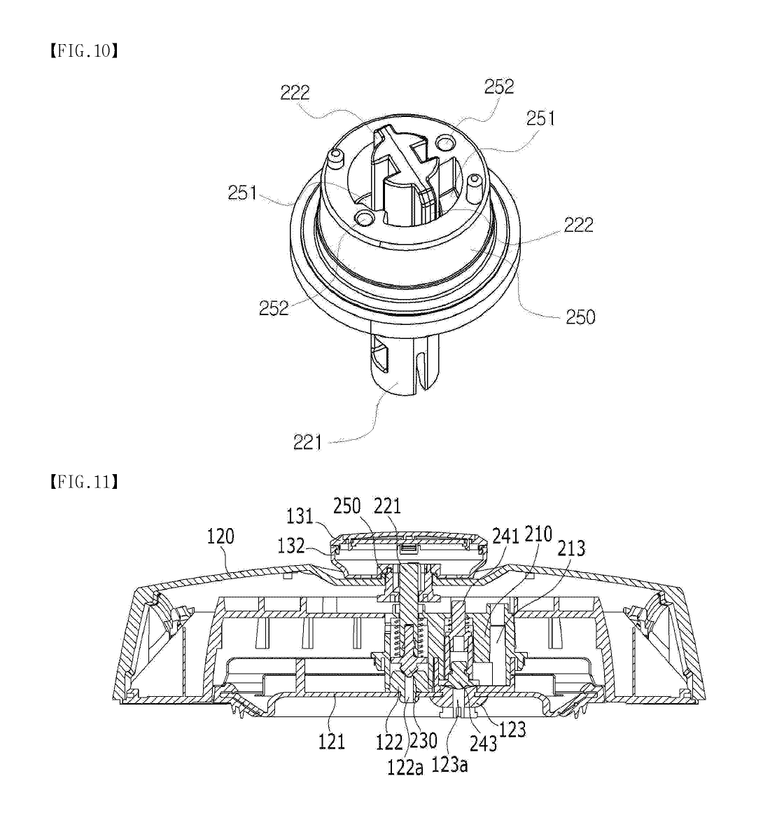

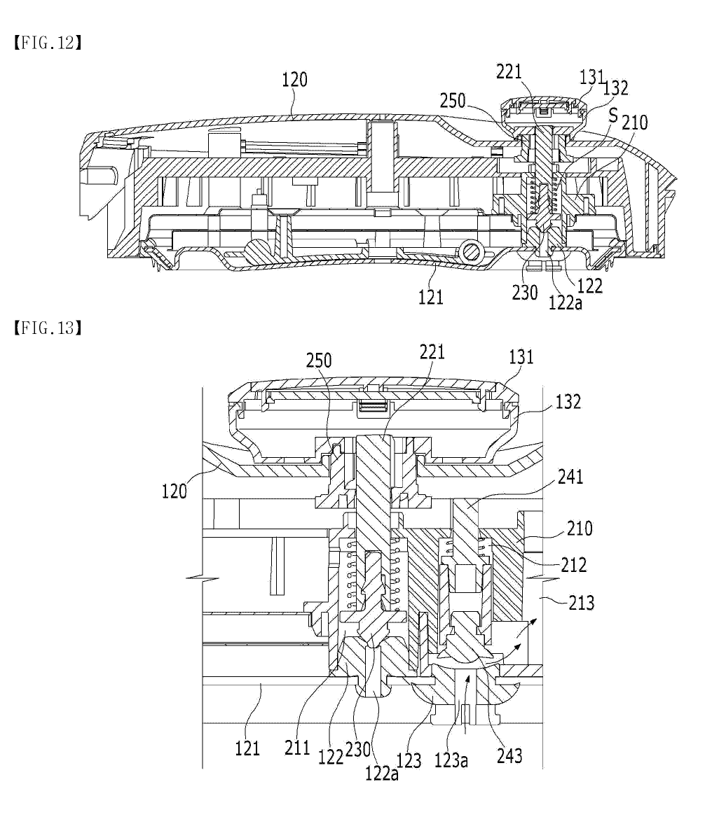

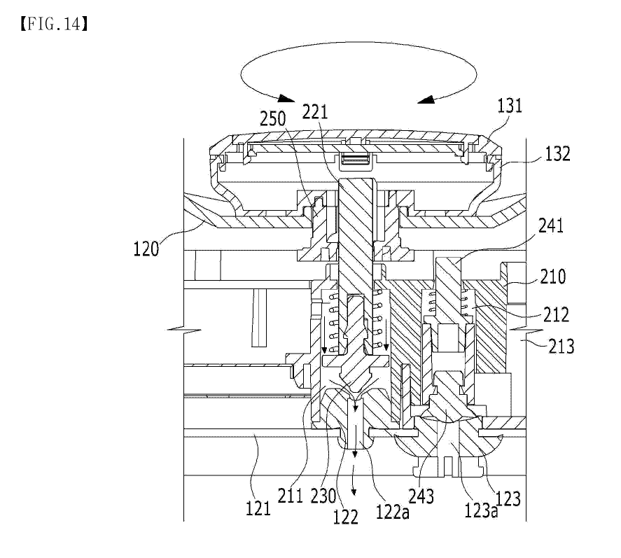

FIG. 2 is a perspective view of an electric rice cooker according to the present invention, FIG. 3 is a perspective view of a lid of the electric rice cooker according to the present invention, FIG. 4 is an exploded perspective view of a low vacuum and vacuum release device of the electric rice cooker according to the present invention, FIG. 5 is a coupled perspective view of the low vacuum and vacuum release device of the electric rice cooker according to the present invention, FIG. 6 is a cross-sectional view taken along a line A-A in FIG. 5, FIG. 7 is a cross-sectional view taken along a line B-B in FIG. 5, FIG. 8 is an exploded perspective view illustrating inner configurations of a vacuum release opening/closing operation shaft and a raising/lowering operation connection part of the low vacuum and vacuum release device according to the present invention, FIG. 9 is an exploded perspective view illustrating the vacuum release opening/closing operation shaft and the raising/lowering operation connection part of the low vacuum and vacuum release device according to the present invention, FIG. 10 is a coupled perspective view illustrating the vacuum release opening/closing operation shaft and the raising/lowering operation connection part of the low vacuum and vacuum release device according to the present invention, FIG. 11 is a transverse sectional view of a lid provided with the low vacuum and vacuum release device of the electric rice cooker according to the present invention, FIG. 12 is a longitudinal sectional view of the lid provided with the low vacuum and vacuum release device of the electric rice cooker according to the present invention, FIG. 13 is an enlarged cross-sectional view of the lid in a state in which vapor of the electric rice cooker according to the present invention is discharged, and FIG. 14 is an enlarged cross-sectional view of the lid in a state in which a vacuum state of the electric rice cooker according to the present invention is released.

As shown in FIGS. 2 to 12, an electric rice cooker 100 according to the present invention includes a lid 120, an operation lever 130, and a low vacuum and vacuum release device 200.

The lid 120 according to the present embodiment is installed to be openable and closable at an upper portion of a main body 110 in which food is contained and cooked by a heat source.

The operation lever 130 according to the present embodiment is rotatably installed at the lid 120 to be able to open and close the lid 120 from the main body 110.

The low vacuum and vacuum release device 200 according to the present embodiment is elastically connected to the operation lever 130 inside the lid 120, and when the operation lever 130 is turned and released, the low vacuum and vacuum release device 200 may be raised by an elastic force to automatically release or maintain a vacuum state inside the electric rice cooker 100.

The low vacuum and vacuum release device 200 according to this embodiment includes a housing 210, a first pressure opening/closing operation part 240, a second vacuum release operation part 220, and a raising/lowering operation connection part 250.

The housing 210 is installed inside the lid 120 to allow the first pressure opening/closing operation part 240 and the second vacuum release operation part 220 to be installed at the housing 210.

A first shaft guide movement space 212 into which the first pressure opening/closing operation part 240 is insertable is formed to vertically pass through a central portion of the housing 210, a second vapor outlet 213 is formed at one side of the housing 210 to communicate with the first shaft guide movement space 212 and to allow vapor to be discharged according to raising and lowering of the first pressure opening/closing operation part 240, and a second shaft guide movement space 211 into which the second vacuum release operation part 220 is insertable is formed to vertically pass through another side of the housing 210.

The second vapor outlet 213 communicates with a first vapor outlet 123a of a first lower sealing member 123 together with the first shaft guide movement space 212, and opens and closes the first vapor outlet 123a of the first lower sealing member 123 according the raising and lowering of the first pressure opening/closing operation part 240, thereby discharging vapor and maintaining a vacuum state.

A guide protrusion 211a is provided at an inner wall surface of the second shaft guide movement space 211 to allow the second vacuum release operation part 220 to be vertically guided.

At this point, the guide protrusion 211a is preferably provided at both inner wall surfaces of the second shaft guide movement space 211 to allow the second vacuum release operation part 220 to be smoothly guided vertically without jolting.

Further, the housing 210 is fixed to a lower heating plate 121 below the lid 120 to open and close the lid 120 from the main body 110 while being rotated according to a rotation of the operation lever 130.

That is, the housing 210 is installed inside the lid 120, and when the first pressure opening/closing operation part 240 is inserted into the first shaft guide movement space 212 and a vapor pressure is raised by heating during cooking, the first pressure opening/closing operation part 240 is raised and the first vapor outlet 123a of the first lower sealing member 123 is opened to discharge vapor, and the second vacuum release operation part 220 is inserted into the second shaft guide movement space 211 and is raised according to a rotation of the operation lever 130, and thus an air inlet 122a of the second lower sealing member 122 is opened such that the vacuum state is released while outside air flows in.

The first pressure opening/closing operation part 240 includes a first upper sealing member guide 241 inserted into the first shaft guide movement space 212 of the housing 210, a first upper sealing member 243 installed below the first upper sealing member guide 241 and configured to open and close the first vapor outlet 123a of the first lower sealing member 123.

A guide part 242 is installed at an outer circumference of the first upper sealing member guide 241 to allow the first upper sealing member guide 241 to be vertically guided inside the first shaft guide movement space 212 without escaping therefrom.

Further, a spring S is installed outside the first upper sealing member guide 241 and is supported on the guide part 242 to allow the first upper sealing member guide 241 to be elastically supported inside the first shaft guide movement space 212.

That is, when the first upper sealing member guide 241 is inserted into the first shaft guide movement space 212, the first upper sealing member guide 241 is supported by the spring S such that the first upper sealing member guide 241 raised by the vapor pressure may be lowered and returned to its original position.

Simultaneously, when food contained in the main body 110 is cooked, the vapor pressure is raised and the first upper sealing member 243, which blocks the first vapor outlet 123a of the first lower sealing member 123, is raised due to the high vapor pressure to open the first vapor outlet 123a such that the high vapor pressure is discharged through the first vapor outlet 123a and the second vapor outlet 213.

Further, when the first vapor outlet 123a is opened due to the high vapor pressure resulting from rising temperature to discharge the vapor and then the pressure inside the main body 10 is lowered while the food is cooked, the first upper sealing member guide 241 and the first upper sealing member 243 are lowered by an elastic force of the spring S to block the first vapor outlet 123a such that the vacuum state is maintained.

Accordingly, the first pressure opening/closing operation part 240 moves vertically according to the pressure inside the electric rice cooker to open and close the first vapor outlet 123a such that a constant amount of pressure may be discharged and maintained.

The second vacuum release operation part 220 includes a vacuum release opening/closing operation shaft 221 inserted into the second shaft guide movement space 211 of the housing 210, and includes a second upper sealing member 230 installed below the vacuum release opening/closing operation shaft 221 and configured to open and close the air inlet 122a of the second lower sealing member 122.

The vacuum release opening/closing operation shaft 221 is inserted into the second shaft guide movement space 211 of the housing 210, and an upper portion of the vacuum release opening/closing operation shaft 221 is fitted to the raising/lowering operation connection part 250.

Further, the vacuum release opening/closing operation shaft 221 is raised and lowered inside the second shaft guide movement space 211 according to a rotation and release of the operation lever 130 to open and close the air inlet 122a of the second lower sealing member 122 such that the vacuum state inside the main body 110 may be released or maintained.

Furthermore, a hook bump 222 is formed at an upper outer side of the vacuum release opening/closing operation shaft 221 to be inserted into and hooked to the raising/lowering operation connection part 250 such that the vacuum release opening/closing operation shaft 221 may be raised and lowered inside the second shaft guide movement space 211 according to the rotation of the operation lever 130.

Additionally, the hook bump 222 is formed at both of left and right sides of the vacuum release opening/closing operation shaft 221 to allow the vacuum release opening/closing operation shaft 221 to be smoothly raised and lowered inside the raising/lowering operation connection part 250 according to a rotation of the operation lever 130, without being inclined to one side.

That is, the vacuum release opening/closing operation shaft 221 is inserted into the second shaft guide movement space 211 of the housing 210, the upper portion of the vacuum release opening/closing operation shaft 221 is inserted into the raising/lowering operation connection part 250, and the vacuum release opening/closing operation shaft 221 connects the housing 210 to the raising/lowering operation connection part 250 so that, when the raising/lowering operation connection part 250 is rotated, the vacuum release opening/closing operation shaft 221 inserted into the second shaft guide movement space 211 and into the raising/lowering operation connection part 250 is raised and lowered inside the second shaft guide movement space 211 and inside the raising/lowering operation connection part 250 by the hook bump 222 hooked to an inner side of the raising/lowering operation connection part 250.

For example, when the raising/lowering operation connection part 250 is rotated in a clockwise direction, the vacuum release opening/closing operation shaft 221 is raised inside the second shaft guide movement space 211 and the raising/lowering operation connection part 250, and when the raising/lowering operation connection part 250 is rotated in a counterclockwise direction, the vacuum release opening/closing operation shaft 221 is lowered inside the second shaft guide movement space 211 and the raising/lowering operation connection part 250.

Further, a spring S is installed outside the vacuum release opening/closing operation shaft 221 to elastically support the vacuum release opening/closing operation shaft 221 inserted into the second shaft guide movement space 211 of the housing 210.

That is, since the vacuum release opening/closing operation shaft 221 inserted into the second shaft guide movement space 211 of the housing 210 is elastically supported by the spring S, when the operation lever 130 is rotated and then released, the raised vacuum release opening/closing operation shaft 221 is lowered by an elastic force of the spring S.

Further, a guide recess 223 is formed on an outer side surface of the vacuum release opening/closing operation shaft 221 to allow the vacuum release opening/closing operation shaft 221, which is fitted to a guide protrusion 211a of the second shaft guide movement space 211 so as to be inserted into the second shaft guide movement space 211, to be vertically guided along the second shaft guide movement space 211.

At this point, a plurality of guide recesses 223 are preferably formed on both sides of the vacuum release opening/closing operation shaft 221 to allow the vacuum release opening/closing operation shaft 221 to be smoothly guided inside the second shaft guide movement space 211.

Consequently, the vacuum release opening/closing operation shaft 221 is inserted into the second shaft guide movement space 211 in a state in which the guide protrusion 211a is fitted to the guide recess 223 such that, when the vacuum release opening/closing operation shaft 221 is raised and lowered by the rotation of the operation lever 130, the vacuum release opening/closing operation shaft 221 may be smoothly raised and lowered by the guide recess 223 and the guide protrusion 211a without jolting.

The second upper sealing member 230 is installed at a lower portion of the vacuum release opening/closing operation shaft 221 by fitting.

Further, the second upper sealing member 230 is simultaneously raised and lowered with raising and lowering of the vacuum release opening/closing operation shaft 221 to open and close the air inlet 122a of the second lower sealing member 122.

Furthermore, a guide plate 230a is installed at an outer circumference of the second upper sealing member 230 to support the spring S and guide the second upper sealing member 230.

As the vacuum release opening/closing operation shaft 221 is raised by the rotation of the operation lever 130, the second upper sealing member 230 is raised to open the air inlet 122a of the second lower sealing member 122 such that outside air flows inside the main body 110 through the air inlet 122a to release the vacuum state, and when the operation lever 130 is released, as the vacuum release opening/closing operation shaft 221 is lowered by the elastic force of the spring S, the second upper sealing member 230 is lowered to block the air inlet 122a of the second lower sealing member 122 such that an interior of the main body 110 is maintained in the vacuum state.

The raising/lowering operation connection part 250 is installed at one side of the upper portion of the housing 210, that is, above the second shaft guide movement space 211 of the housing 210.

The upper portion of the vacuum release opening/closing operation shaft 221 inserted into the second shaft guide movement space 211 is inserted inside the raising/lowering operation connection part 250.

Further, as shown in FIGS. 8 to 10, a raising/lowering inclination guide part 251 is installed on an inner wall surface of the raising/lowering operation connection part 250 such that the hook bump 222 is hooked to the raising/lowering inclination guide part 251 while the vacuum release opening/closing operation shaft 221 is inserted to allow the vacuum release opening/closing operation shaft 221 to be raised and lowered according to a rotation of the raising/lowering operation connection part 250.

The raising/lowering inclination guide part 251 is installed at both sides of the inner wall surface of the raising/lowering operation connection part 250 such that the hook bump 222 of the vacuum release opening/closing operation shaft 221 is hooked to the two raising/lowering inclination guide parts 251 to allow the vacuum release opening/closing operation shaft 221 to be raised and lowered according to the rotation of the raising/lowering operation connection part 250.

Alternatively, the two raising/lowering inclination guide part 251 are installed to cross each other and be inclined at both sides of the inner wall surface of the raising/lowering operation connection part 250.

That is, the upper portion of the vacuum release opening/closing operation shaft 221 is inserted into the raising/lowering operation connection part 250, and when the hook bump 222 is hooked to the raising/lowering inclination guide part 251 and the vacuum release opening/closing operation shaft 221 is raised according to the rotation of the raising/lowering operation connection part 250, the two raising/lowering inclination guide parts 251 are formed to cross each other and be inclined on the inner wall surface of the raising/lowering operation connection part 250 so that, when the raising/lowering operation connection part 250 is rotated in one direction, the hook bump 222 is rotated upward along the two raising/lowering inclination guide parts 251 such that the vacuum release opening/closing operation shaft 221 is raised, and when the raising/lowering operation connection part 250 is rotated in another direction, the hook bump 222 is rotated downward along the two raising/lowering inclination guide parts 251 such that the vacuum release opening/closing operation shaft 221 is lowered.

Further, a bolt hole 252 is formed at an upper portion of the raising/lowering operation connection part 250 to allow the raising/lowering operation connection part 250 to be fixed to the operation lever 130 by a bolt B.

The operation lever 130 of the present invention includes a lower plate 131 fixed to the raising/lowering operation connection part 250 by the bolt B and includes an upper plate 132 installed at an upper portion of the lower plate 131 by fitting.

As described above, the raising/lowering operation connection part 250 to which the vacuum release opening/closing operation shaft 221 is coupled is brought into close contact with a lower portion of the lower plate 131, and the bolt B is engaged with the bolt hole 252 such that the raising/lowering operation connection part 250 is fixed to the lower plate 131, and the upper plate 132 is installed at the upper portion of the lower plate 131 to which the raising/lowering operation connection part 250 is fixed, and thus an interior of the operation lever 130 is not visible, such that an aesthetic pleasure from an exterior can be increased.

An operation of the low vacuum and vacuum release device of the electric rice cooker according to the present invention, which is constituted by the above-described configuration, will be described below.

The lid 120 is installed to be openable and closable at an upper portion of the main body 110, and the operation lever 130 is installed at the lid 120 such that the lid 120 may be locked to and unlocked from the main body 110 by a rotation of the operation lever 130.

At this point, when the operation lever 130 is rotated to open the lid 120 while the second vacuum release operation part 220 of the low vacuum and vacuum release device 200 is connected to the operation lever 130 inside the lid 120, the pressure inside the main body 110 is discharged and the vacuum state is released such that the lid 120 may be opened.

That is, when the operation lever 130 is rotated, the hook bump 222 hooked to the raising/lowering inclination guide part 251 of the raising/lowering operation connection part 250 is raised along the raising/lowering inclination guide part 251 when the raising/lowering operation connection part 250 installed at the operation lever 130 is rotated together therewith the operation lever 130, so that the vacuum release opening/closing operation shaft 221 inserted into the second shaft guide movement space 211 is raised.

As shown in FIG. 14, as the vacuum release opening/closing operation shaft 221 is raised, the second upper sealing member 230, which has blocked the air inlet 122a of the second lower sealing member 122, is raised to open the air inlet 122a such that the outside air flows inside the main body 110 through the air inlet 122a to release the vacuum state inside the main body 110.

Consequently, as the operation lever 130 is rotated, the vacuum release opening/closing operation shaft 221 is raised and the second upper sealing member 230 opens the air inlet 122a of the second lower sealing member 122, and thus the vacuum state inside the main body 110 is released due to the inflow of the outside air such that the lid 120 may be easily opened.

Further, when the operation lever 130 is released in a state in which the vacuum release opening/closing operation shaft 221 is raised by the rotation of the operation lever 130 and the raising/lowering operation connection part 250, the vacuum release opening/closing operation shaft 221 is lowered along the guide recess 223 by the elastic force of the spring S such that the vacuum release opening/closing operation shaft 221 is lowered.

Furthermore, as the vacuum release opening/closing operation shaft 221 is lowered, the second upper sealing member 230 blocks the air inlet 122a of the second lower sealing member 122.

Therefore, as the raising/lowering operation connection part 250 is rotated by the rotation of the operation lever 130, the vacuum release opening/closing operation shaft 221 is raised in a compressed state by a pressing force of the spring S such that the second upper sealing member 230 opens the air inlet 122a of the second lower sealing member 122 to release the vacuum state, and as the vacuum release opening/closing operation shaft 221 is rotated and lowered along the raising/lowering inclination guide part 251 by the elastic force of the spring S, the vacuum release opening/closing operation shaft 221 and the second upper sealing member 230 return to their original positions and the second upper sealing member 230 blocks the air inlet 122a such that the outside air is blocked to maintain the vacuum state inside the main body 110.

Further, as shown in FIG. 13, when the vapor pressure generated by the heat source is high while the food contained in the main body 110 is being cooked, the first upper sealing member 243 blocking the first vapor outlet 123a of the first lower sealing member 123 is, due to the high vapor pressure, pushed upward and the first upper sealing member guide 241 is raised such that the first vapor outlet 123a and the second vapor outlet 213 are opened to discharge the high vapor pressure to prevent an explosion and the food from burning.

Furthermore, when the first upper sealing member guide 241 is raised by the high vapor pressure to discharge the high vapor pressure and then the vapor pressure is lowered, the first upper sealing member guide 241 is lowered by the elastic force of the spring S and the first upper sealing member 243 blocks the first vapor outlet 123a of the first lower sealing member 213, and thus the vapor pressure is not discharged, such that the pressure inside the main body 110 is kept constant to allow the food to be cooked to the best taste.

Accordingly, in accordance with the present invention, the vacuum state inside the main body 110 is released by the rotation of the operation lever 130 according to the operation of the low vacuum and vacuum release device 200 connected to the operation lever 130, which is installed inside the lid 120 such that the lid 120 can be opened, and the operated operation lever 130 returns automatically to its original position due to the elastic force of the spring S such that the interior of the main body 110 can achieve a vacuum state to improve heat insulating efficiency and user convenience.

It will be apparent to those skilled in the art that various modifications can be made in the present invention without departing from the spirit and scope of the present invention as defined in the appended claims, and it should be understood that such modifications fall within the scope of the appended claims.

1. A low vacuum and vacuum release device for an electric rice cooker, comprising:
an operation lever installed at an upper portion of a lid,
wherein the low vacuum and vacuum release device is installed inside the lid and is elastically connected to the operation lever, and, when the operation lever is rotated, a second upper sealing member is raised to open an air inlet such that outside air flows in to release a vacuum state, and, when the operation lever is released, the second upper sealing member is lowered by an elastic force of a spring to block the air inlet such that sealing is accomplished to maintain the vacuum state.

2. The device of claim 1, wherein the low vacuum and vacuum release device includes:
a housing installed inside the lid;
a first pressure opening/closing operation part installed inside the housing and configured to open and close a first vapor outlet of a first lower sealing member by being raised and lowered according to a vapor pressure during cooking;
a second vacuum release operation part installed inside the housing and configured to open and close an air inlet of a second lower sealing member by being raised and lowered according to a rotation of the operation lever; and
a raising/lowering operation connection part installed at an upper portion of the housing and configured to raise and lower the second vacuum release operation part by being fixed to the operation lever.

3. The device of claim 2, wherein the housing includes:
a second shaft guide movement space formed to vertically pass through the housing to allow the second vacuum release operation part to be inserted;
a first shaft guide movement space into which the first pressure opening/closing operation part is inserted; and
a second vapor outlet configured to communicate with the first shaft guide movement space and the first vapor outlet and allow vapor to be discharged according to raising and lowering of the first pressure opening/closing operation part.

4. The device of claim 3, wherein a guide protrusion is provided at both sides of an inner wall surface of the second shaft guide movement space to allow the second vacuum release operation part to be vertically smoothly guided.

5. The device of claim 2, wherein the first pressure opening/closing operation part includes:
a first upper sealing member guide inserted into the first shaft guide movement space of the housing;
a first upper sealing member installed below the first upper sealing member guide and configured to, by being raised and lowered by heating during cooking and according to the vapor pressure, open and close a second vapor outlet to open and close the first vapor outlet of the first lower sealing member to adjust discharge of a pressure; and
a spring installed outside the first upper sealing member guide and configured to elastically support the first upper sealing member guide inside a first shaft guide movement space.

6. The device of claim 5, wherein a guide part is installed at an outer circumference of the first upper sealing member guide to allow the first upper sealing member guide to be guided from the first shaft guide movement space.

7. The device of claim 2, wherein the second vacuum release operation part includes:
a vacuum release opening/closing operation shaft installed inside a second shaft guide movement space of the housing, and having an upper portion fitted to the raising/lowering operation connection part and configured to be raised and lowered according to the rotation of the operation lever;
a second upper sealing member installed at a lower portion of the vacuum release opening/closing operation shaft by fitting, and configured to be in close contact with an air inlet of the second lower sealing member and to open and close the air inlet according to raising and lowering of the vacuum release opening/closing operation shaft to maintain or release a vacuum state inside a main body; and
a spring installed outside the vacuum release opening/closing operation shaft and configured to elastically support the vacuum release opening/closing operation shaft inserted into the second shaft guide movement space.

8. The device of claim 7, wherein a plurality of hook bumps are formed at both outer left and right sides of an upper portion of the vacuum release opening/closing operation shaft to be hooked to a raising/lowering inclination guide part of the raising/lowering operation connection part, thereby allowing the vacuum release opening/closing operation shaft to be raised according to the rotation of the operation lever.

9. The device of claim 7, wherein a plurality of guide recesses are formed at both outer left and right sides of the vacuum release opening/closing operation shaft, and guide protrusions provided in the second shaft guide movement space are inserted into the plurality of guide recesses to allow the vacuum release opening/closing operation shaft to be vertically guided.

10. The device of claim 7, wherein a guide plate is installed at an outer circumference of the second upper sealing member to support the spring and guide the second upper sealing member.

11. The device of claim 2, wherein raising/lowering inclination guide parts are installed to cross each other and be inclined at both sides of an inner wall surface of the raising/lowering operation connection part, and when a vacuum release opening/closing operation shaft is inserted, and a hook bump is hooked to the raising/lowering inclination guide parts, thereby raising and lowering the vacuum release opening/closing operation shaft according to the rotation of the operation lever.

12. The device of claim 2, wherein a bolt hole is formed at an upper portion of the raising/lowering operation connection part to allow the raising/lowering operation connection part to be fixed to the operation lever by a bolt.

13. The device of claim 2, wherein the operation lever includes a lower plate fixed to the raising/lowering operation connection part by a bolt and includes an upper plate installed at an upper portion of the lower plate by fitting.
